(19) United States
(12) Patent Application Publication
(10) Pub. No.: US 2025/0371996 A1
(43) Pub. Date: Dec. 4, 2025

(54) ASSESSMENT SYSTEM FOR MEDICAL CLINICAL SKILLS

(71) Applicant: TAIPEI MEDICAL UNIVERSITY, Taipei City (TW)

(72) Inventors: Che-Wei LIN, Taipei City (TW); Phung Anh NGUYEN, New Taipei City (TW); Chih-Wei HUANG, New Taipei City (TW)

(21) Appl. No.: 19/224,047

(22) Filed: May 30, 2025

Related U.S. Application Data
(60) Provisional application No. 63/654,208, filed on May 31, 2024.

(30) Foreign Application Priority Data
May 31, 2024 (TW) 113120159

(51) Int. Cl. G09B 19/00

(52) U.S. Cl. CPC G09B 19/00

(57) ABSTRACT

Provided is an assessment system for medical clinical skills, including an image processing module, a deep learning module, and a medical clinical skills assessment module. The image processing module receives execution videos of medical clinical skills and annotation information, where each execution video includes target actions executed consecutively. The image processing module further performs annotation processing for each execution video based on the annotation information and divides each execution video into execution segments, where each execution segment corresponds to one of the target actions. The deep learning module compiles and performs recognition processing on the execution segments that execute the same target action in the execution videos, establishing assessment benchmark videos corresponding to each target action. The medical clinical skills assessment module receives a to-be-assessed video and sequentially compares the to-be-assessed video with each assessment benchmark video to determine whether the to-be-assessed video effectively executes each target action.

### CROSS REFERENCE TO RELATED APPLICATIONS

This patent application claims the benefit of U.S. Provisional Ser. No. 63/654,208, filed May 31, 2024, and claims priority to TW113120159, filed May 31, 2024, the entire contents of which are incorporated herein by reference.

### BACKGROUND

### Technical Field

The present disclosure relates to a medical clinical skills assessment system, and particularly to a medical clinical skills assessment system for operative-type medical clinical skills, in which a deep learning prediction model is utilized to assess the operations performed by a subject.

### Description of Related Art

The Objective Structured Clinical Examination (OSCE) is currently a method widely used in the medical field to assess the abilities of subjects, in which standardized patients and models are used to test the communication skills and skill operation abilities of the subjects. Conventional Objective Structured Clinical Examinations require the presence of an examiner on-site to assess the test-taking process of the subject. However, this easily leads to issues of reliability. For example, since examiners often need to perform assessment for up to 3 hours or even longer, personal physical or mental fatigue is likely to cause the aforementioned variation in reliability; or, sometimes due to the large number of test-takers, it is necessary to conduct the examination simultaneously in different testing venues, and the same test question may lead to variations in reliability among examiners in different venues.

In addition, in medical education, in addition to the transmission of knowledge, the teaching of skills is even more important. The transmission of knowledge can be completed through methods such as distance teaching and online self-learning; however, the teaching of skills mostly relies on an apprenticeship-based teaching model. After the teacher explains and demonstrates the operation of a relevant skill, the student performs executions of the related skill operation, and then the teacher observes on-site and provides timely guidance and feedback to the student. Nevertheless, conventional skill teaching requires both the teacher and the student to be able to make time and space available for implementation, which poses many inconveniences to either party.

Therefore, it is truly an urgent issue that needs to be solved at present as to how to design a medical clinical skills assessment system that can effectively improve the aforementioned problems.

### SUMMARY

The present disclosure provides a medical clinical skills assessment system that utilizes a deep learning prediction model to assess a subject's performance of operative-type medical clinical skills.

In at least one embodiment, the medical clinical skills assessment system of the present disclosure comprises an image processing module, a deep learning module, and a medical clinical skills assessment module. In some embodiments of the present disclosure, the image processing module is configured to receive a plurality of execution videos of medical clinical skills and a plurality of annotation information, wherein each of the execution videos includes a plurality of target actions executed consecutively, and the image processing module is configured to perform annotation processing for each of the execution videos based on the plurality of annotation information and divide each of the execution videos into a plurality of execution segments, wherein each of the execution segments corresponds to one of the plurality of target actions being executed; the deep learning module is configured to compile and perform recognition processing on the execution segments executing a same target action in the plurality of execution videos, so as to establish a corresponding assessment benchmark video for each of the target actions; and the medical clinical skills assessment module is configured to receive a to-be-assessed video of performing the medical clinical skills and sequentially compare the to-be-assessed video with each of the assessment benchmark videos to determine whether the to-be-assessed video executes each of the target actions, thereby generating a corresponding assessment result.

In at least one embodiment of the present disclosure, the plurality of annotation information includes a plurality of start markers and a plurality of end markers, and the image processing module is configured to mark a start time point of a corresponding target action according to each of the start markers and mark an end time point of the corresponding target action according to each of the end markers.

In at least one embodiment of the present disclosure, the plurality of annotation information further includes a plurality of assessment markers, and the image processing module is configured to mark at least one of an evaluation score, a grade, and a performance level of the corresponding target action according to each of the assessment markers.

In at least one embodiment of the present disclosure, the plurality of assessment markers are provided based on whether each of the target actions in each of the execution videos is fully executed, partially executed, or not executed to give a corresponding assessment result for each of the target actions.

In at least one embodiment of the present disclosure, the image processing module is configured to perform a batch capture operation based on a time point position of each of the start markers and a corresponding time point position of each of the end markers in the plurality of annotation information to obtain the plurality of execution segments of the execution videos.

In at least one embodiment of the present disclosure, the plurality of execution videos include a multi-angle image of performing the medical clinical skills.

In at least one embodiment of the present disclosure, the image processing module is configured to perform facial de-identification processing on each of the execution videos.

In at least one embodiment of the present disclosure, the medical clinical skills assessment system further comprises an image capture module and an auxiliary recognition module, wherein the image capture module is configured to obtain the to-be-assessed video, and the auxiliary recognition module is configured to provide auxiliary recognition information of the to-be-assessed video.

In at least one embodiment of the present disclosure, the image processing module is connected to a network server to receive the plurality of execution videos and/or the plurality of annotation information from the network server.

In at least one embodiment of the present disclosure, the medical clinical skills assessment system further comprises a storage module configured to store at least one of the plurality of execution videos, the plurality of annotation information, the plurality of execution segments, and each of the assessment benchmark videos.

### BRIEF DESCRIPTION OF DRAWINGS

By reading the descriptions of the following embodiments and referring to the accompanying drawings, the present disclosure can be more fully understood.

FIG. 1 is a system block diagram of the medical clinical skills assessment system of the present disclosure.

FIG. 2 is a schematic diagram of the execution of the medical clinical skills assessment system of the present disclosure.

FIG. 3 is a schematic diagram of comprehensive prediction results obtained by using the medical clinical skills assessment system of the present disclosure to process a plurality of training execution videos of CPR and AED operations.

FIG. 4 is a schematic diagram of comprehensive prediction results obtained by using the medical clinical skills assessment system of the present disclosure to process a plurality of verification execution videos of CPR and AED operations.

FIG. 5 is a system block diagram of another embodiment of the medical clinical skills assessment system of the present disclosure.

FIG. 6 is a system block diagram of yet another embodiment of the medical clinical skills assessment system of the present disclosure.

### DETAILED DESCRIPTION

Since the various aspects and embodiments are illustrative and not restrictive, after reading this specification, a person having ordinary knowledge may also understand other aspects and embodiments without departing from the scope of the present disclosure. According to the following detailed description and the scope of the patent application, the features and advantages of these embodiments can be further elaborated.

In this disclosure, the term “a” or “an” to describe the elements and components as described herein is merely for the convenience of description and provides a general meaning for the scope of the present disclosure. Therefore, unless clearly stated otherwise, such description should be understood to include one or at least one, and the singular also includes the plural.

In this disclosure, the terms “comprise,” “have,” “include,” or any other similar terms are intended to cover non-exclusive inclusions. For example, a component or structure that contains multiple elements is not limited to only those elements listed herein but may also include other elements not explicitly listed that are ordinarily inherent to the component or structure.

The medical clinical skills assessment system of the present disclosure mainly performs assessment on medical clinical skills performed by any subject to determine whether the subject effectively and correctly executes each required action of the medical clinical skills, so as to generate a corresponding assessment result. Medical clinical skills are defined as basic operational skills required for medical personnel or learners who are engaging or preparing to engage in clinical work, such as basic life support (BLS), nasogastric tube intubation, urinary catheterization, blood drawing, wound dressing management, etc. In the present disclosure, medical clinical skills are explained using skills such as cardiopulmonary resuscitation (CPR) in basic life support, automated external defibrillator (AED), nasogastric tube intubation, and urinary catheter insertion as embodiments, but medical clinical skills are not limited thereto. It should be understood that the present disclosure is also applicable to other medical clinical skills.

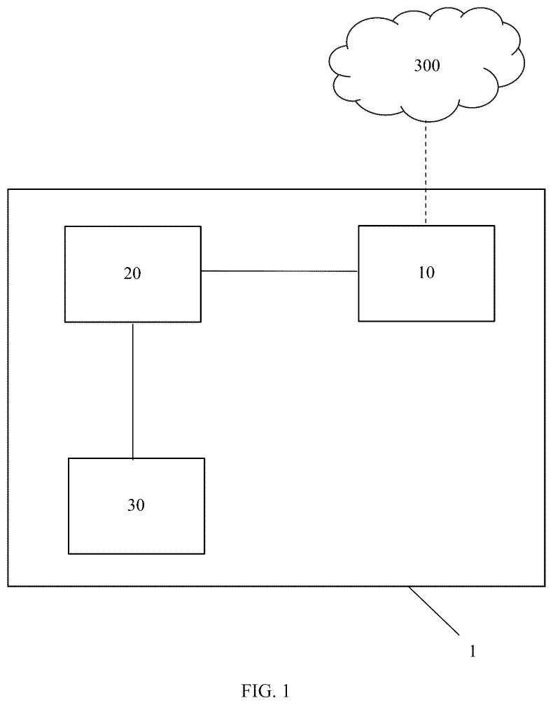

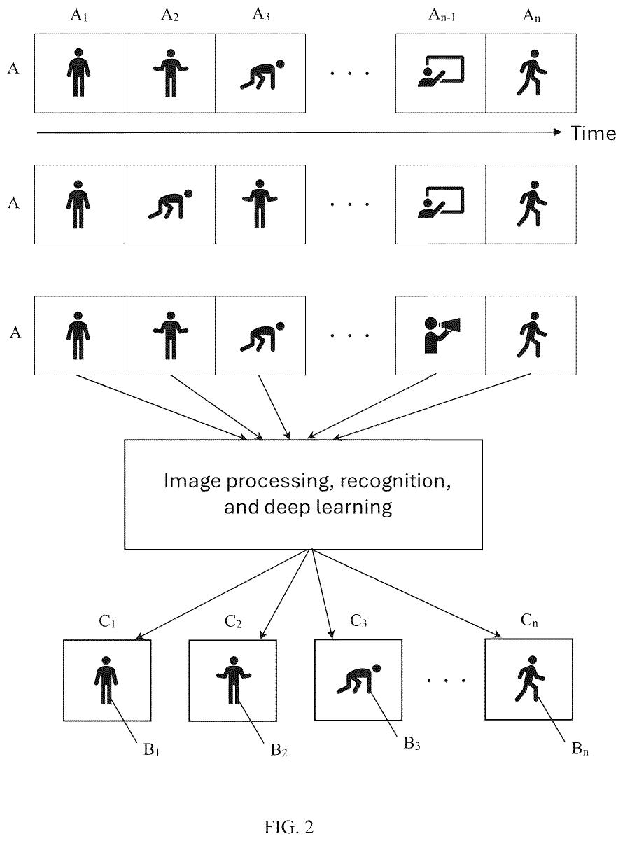

Please refer to FIG. 1 and FIG. 2, wherein FIG. 1 is a system block diagram of the medical clinical skills assessment system of the present disclosure, and FIG. 2 is a schematic diagram of the execution of the medical clinical skills assessment system of the present disclosure. As shown in FIG. 1 and FIG. 2, the medical clinical skills assessment system 1 of the present disclosure can be configured as hardware (such as a computer host, a server, or a similar device), software (such as computer software or applications), or a combination of the aforementioned hardware and software. The medical clinical skills assessment system 1 of the present disclosure comprises an image processing module 10, a deep learning module 20, and a medical clinical skills assessment module 30, and the image processing module 10 and the medical clinical skills assessment module 30 are electrically connected to the deep learning module 20, respectively.

In at least one embodiment of the present disclosure, the image processing module 10 is configured to receive a plurality of execution videos of medical clinical skills and a plurality of annotation information and perform annotation processing for each of the execution videos based on the plurality of annotation information. In some embodiments of the present disclosure, the image processing module 10 may be a combination of hardware devices having image processing functions, such as a processor, and related image processing software, and the aforementioned image processing software may be stored in a hardware device with data storage capability; however, the present disclosure is not limited thereto. For example, the image processing module 10 may also be standalone software or hardware. In some embodiments of the present disclosure, the image processing module 10 may connect to a network server 300 or database via a network to receive the plurality of execution videos and/or the plurality of annotation information from the network server 300 or database (as shown in FIG. 1). In other embodiments of the present disclosure, the image processing module 10 may also be electrically connected to a storage device or a data input device of the medical clinical skills assessment system 1 of the present disclosure to receive the plurality of execution videos and/or the plurality of annotation information from the storage device or the data input device.

In at least one embodiment of the present disclosure, each of the execution videos in the aforementioned plurality of execution videos is a continuous motion video recording of any subject performing medical clinical skills, and each of the execution videos includes a plurality of target actions executed consecutively; that is, the medical clinical skills in the present disclosure are composed of a plurality of consecutive target actions, wherein the plurality of execution videos may include training or testing videos of subjects or learners performing the medical clinical skills, as well as demonstration videos of experts performing the medical clinical skills. In some embodiments of the present disclosure, the plurality of execution videos may include videos recorded from a single angle showing the subject performing the medical clinical skill. However, depending on system requirements or subsequent processing methods, the plurality of execution videos may also include videos recorded from multiple angles showing the subject performing the medical clinical skill.

In at least one embodiment of the present disclosure, each of the execution videos is basically composed of a plurality of consecutive still images, and each of the execution videos corresponds to a timeline. Based on the chronological order of the timeline, the plurality of still images are sequentially displayed to present the entire process of performing the medical clinical skill, namely, the continuous execution process of the plurality of target actions of the medical clinical skill. In some embodiments of the present disclosure, the image processing module 10 adds or updates the plurality of execution videos either manually (e.g., manually connecting to an external storage device) or automatically (e.g., periodically or non-periodically connecting to a network server 300 or database) to provide more and updated execution videos of medical clinical skills.

In at least one embodiment of the present disclosure, the plurality of execution videos may be categorized into a plurality of training execution videos and a plurality of verification execution videos. The plurality of training execution videos are used to provide the system with various target actions for recognition and assessment learning when performing medical clinical skills, and the plurality of verification execution videos are used to provide the system for verifying the accuracy of the various target actions previously recognized and assessed. In some embodiments of the present disclosure, the ratio of the number of training execution videos to verification execution videos may be, for example, 5:1, 4:1, or 3:1. For example, when the ratio is 4:1, the number of the training execution videos accounts for 80% of the total number of the execution videos, and the number of the verification execution videos accounts for 20% of the total number of the execution videos; however, the aforementioned ratio is not limited thereto.

In some embodiments of the present disclosure, the aforementioned plurality of annotation information is annotation formed via labeling and rating performed by experts or professionals who perform the medical clinical skills for each of the target actions in each of the execution videos. In some embodiments of the present disclosure, the plurality of annotation information may include a plurality of start markers, a plurality of end markers, and a plurality of assessment markers. For example, each of the start markers is used to mark a start time point of a corresponding target action, and each of the end markers is used to mark an end time point of the corresponding target action. Based on the start and end markers of the same target action, the execution time of the target action can be obtained. In some embodiments of the present disclosure, each of the assessment markers can be used to mark assessment results such as an assessment score, a grade, or a performance level for the corresponding target action. In some embodiments of the present disclosure, the image processing module 10 can similarly add or update the plurality of annotation information manually (e.g., manually inputting via an external data input device) or automatically (e.g., connecting periodically or non-periodically to the network server 300 or database).

In at least one embodiment of the present disclosure, the plurality of assessment markers are assigned by the aforementioned experts or professionals based on relevant standards or rules for performing medical clinical skills to determine whether each of the target actions in each of the execution videos is fully executed, partially executed, or not executed, thereby assigning corresponding assessment results such as an assessment score, a grade, or a performance level to each of the target actions.

In at least one embodiment of the present disclosure, after receiving the plurality of annotation information, the image processing module 10 processes relevant annotation for the plurality of target actions in the corresponding execution videos based on the plurality of annotation information, such that each of the target actions can have a corresponding start marker, end marker, and assessment marker. In some embodiments of the present disclosure, the image processing module 10 then divides each of the execution videos into a plurality of execution segments based on the plurality of annotation information, wherein each of the execution segments corresponds to one of the plurality of target actions being executed. For example, the image processing module 10 may perform batch capture operations based on the time point positions of each start marker and its corresponding end marker in the plurality of annotation information, so as to obtain the plurality of execution segments of the execution videos. In other words, the content of each of the captured execution segments corresponds to the continuous images of executing a target action. In some embodiments of the present disclosure, in order to reduce the storage space occupied by the execution segments and allow the system to perform subsequent image processing more quickly, in at least one embodiment of the present disclosure, the image processing module 10 executes batch capture of the plurality of execution segments in JSON (JavaScript Object Notation) format; however, the data format used in the present disclosure is not limited thereto.

In some embodiments of the present disclosure, during the aforementioned image processing procedure, the image processing module 10 may perform facial de-identification processing for each of the execution videos to protect the portrait rights and privacy of the individuals executing the actions shown in each of the execution videos or in each of the captured execution segments.

In at least one embodiment of the present disclosure, the deep learning module 20 is configured to compile and perform recognition processing on the execution segments that execute the same target action in the plurality of execution videos, so as to establish a corresponding assessment benchmark video for each of the target actions. In some embodiments of the present disclosure, the deep learning module 20 may be a combination of hardware devices with data learning capabilities, such as processors, and related data learning software, such as artificial intelligence models or artificial neural network architectures, but the present disclosure is not limited thereto. For example, the deep learning module 20 may also be standalone software or hardware. In the present disclosure, since the content of each of the execution videos mainly involves performing the selected medical clinical skill, the same or similar target actions are expected to appear during the process of performing the medical clinical skill. Therefore, the deep learning module 20 of the present disclosure will select the execution segments that execute the same target action from the plurality of execution videos, and after compiling, form a plurality of execution segment groups, wherein each of the execution segment groups contains execution segments that execute the same target action.

In some embodiments of the present disclosure, the deep learning module 20 further performs action recognition and analysis on each of the execution segment groups to identify the action characteristics and content of each of the target actions and establish a corresponding assessment benchmark video for each of the target actions. The deep learning module 20 can obtain the execution time of the corresponding target action according to the start marker and the end marker of each of the execution segments, and recognize and analyze the action characteristics and content of the corresponding target action, as well as utilize the assessment marker to confirm a reasonable time range and actions for executing the corresponding target action, thereby generating more accurate assessment benchmarks.

In some embodiments, the deep learning module 20 of the present disclosure may adopt the Two-Stream Inflated 3D ConvNets (I3D) technique for recognizing human behavior in videos. This technique mainly integrates vertical image stacking (RGB), incorporating the concept of the time dimension (Flow) along the longitudinal axis and enhancing training effects through network expansion. However, the present disclosure may also adopt other learning models or techniques and is not limited thereto.

In at least one embodiment of the present disclosure, the medical clinical skills assessment module 30 is configured to receive a to-be-assessed video of performing a medical clinical skill and sequentially compare the to-be-assessed video with each of the assessment benchmark videos, so as to determine whether the to-be-assessed video executes each of the target actions, thereby generating a corresponding assessment result. In some embodiments of the present disclosure, the medical clinical skills assessment module 30 may be a combination of hardware devices with data comparison and assessment functions, such as processors, and related software for data comparison and assessment; however, the present disclosure is not limited thereto. For example, the medical clinical skills assessment module 30 may also be standalone software or hardware. In at least one embodiment of the present disclosure, the aforementioned to-be-assessed video is a continuous motion video recording of any subject performing the medical clinical skill.

In at least one embodiment of the present disclosure, after the assessment benchmark videos for the plurality of target actions of the medical clinical skills are established by the deep learning module 20 and when the medical clinical skills assessment module 30 of the medical clinical skills assessment system 1 of the present disclosure receives a to-be-assessed video of performing the medical clinical skill (e.g., a video recorded in real time by a camera or other image capture module, or a prerecorded video), the medical clinical skills assessment module 30 can sequentially compare the to-be-assessed video with each of the assessment benchmark videos established by the aforementioned deep learning module 20, so as to determine whether the to-be-assessed video executes each of the target actions, thereby generating a corresponding assessment result to allow the subject to verify the strengths and weaknesses of their performed medical clinical skills.

The following will explain, by way of several embodiments, the plurality of target actions defined for different medical clinical skills by the medical clinical skills assessment system of the present disclosure. First, in at least one embodiment of the present disclosure, the operation of CPR and AED is taken as the medical clinical skill, and the present disclosure refers to the internationally recognized 2016 Edition of the American Heart Association (AHA) Adult CPR and AED Skills Checklist and clinical CPR guidelines to formulate multiple action items as shown in Table 1 and to serve as the assessment content defining the plurality of target actions for CPR and AED operations and as the main basis for assigning assessment markers.

TABLE 1

| Item No. | Assessment Content of Target Action |
|---|---|
| 1 | Confirming environmental safety |
| 2 | Assessing consciousness |
| 3 | Instructing bystanders to call 911 and obtaining the AED |
| 4 | Assessing breathing |
| 5 | Chest compression speed |
| 6 | Chest compression depth |
| 7 | Continuous, uninterrupted chest compressions |
| 8 | Chest compression posture |
| 9 | Timing of power-on and operating sequence |
| 10 | Warning everyone to step away when shock is advised |
| 11 | Immediate CPR after defibrillation |
| 12 | Hand gesture of chest compression |
| 13 | Chest compression position |

In at least one embodiment of the present disclosure, the operation of nasogastric tube intubation is taken as the medical clinical skill, and based on the current procedural assessment steps for nasogastric tube intubation, multiple action items as shown in Table 2 are formulated to serve as the definition of the plurality of target actions of nasogastric tube intubation and as the main basis for assigning assessment markers.

TABLE 2

| Item No. | Assessment Content of Target Action |
|---|---|
| 1 | Handwashing |
| 2 | Putting on appropriate gloves |
| 3 | Completely unwrapping the nasogastric tube and applying |
| | Xylocaine jelly |
| 4 | Evenly spreading Xylocaine jelly onto the nasogastric tube |
| | by hand |
| 5 | Instructing the patient to straighten their upper body or |
| | adjusting the bed's upper portion accordingly |
| 6 | Slightly tilting the patient's head forward |
| 7 | Informing the patient that the nasogastric tube will be |
| | inserted and that it may feel uncomfortable |
| 8 | Inserting the nasogastric tube upward through the nostril, |
| | then angling slightly inward, and pushing forward |
| 9 | Pausing slightly upon encountering resistance after a short |
| | advancement (to the root of the tongue) |
| 10 | Instructing the patient to swallow, then taking the |
| | opportunity to advance the nasogastric tube downward (if |
| | unable to cooperate with swallowing, as the esophagus is |
| | behind the trachea, the mouth may be opened by swab and |
| | the nasogastric tube may be pushed against the oral wall |
| | and then advanced downward) |
| 11 | Advancing the nasogastric tube downward to |
| | approximately 60 cm |
| 12 | Fixing the nasogastric tube at the nostril with one hand, |
| | placing a stethoscope over the stomach, and with the other |
| | hand, using a syringe to inject 30 mL of air |
| 13 | Confirming that the sound of air injection is heard in the |
| | stomach; the action in item (9) can be repeated two to three |
| | times |
| 14 | Using adhesive tape to affix and secure the nasogastric |
| | tube at the nostril |

In at least one embodiment of the present disclosure, the operation of urinary catheter insertion is used as the medical clinical skill, and the present disclosure refers to the current procedural assessment steps for male urinary catheter insertion, and formulates multiple action items as shown in Table 3 to serve as the main basis for defining the plurality of target actions of urinary catheter insertion and assigning assessment markers.

TABLE 3

| Item No. | Assessment Content of Target Action |
|---|---|
| 1 | Correctly wearing sterile gloves |
| 2 | Properly disinfecting the urethral opening |
| 3 | Placing the fenestrated drape |
| 4 | Ensuring sufficient lubrication on the urinary catheter |
| 5 | Correctly inserting the urinary catheter into the urethra |
| 6 | Lightly pressing the upper edge of the pubic bone to |
| | confirm urine outflow |
| 7 | Drawing and injecting distilled water to inflate the |
| | urinary catheter balloon |
| 8 | Connecting the urinary catheter to the urine bag |
| 9 | Securing the urinary catheter to the patient |
| 10 | Cleaning up the catheterization kit |

Accordingly, as long as any medical clinical skill can be broken down into multiple target actions and defined, the medical clinical skills assessment system of the present disclosure can be applied to identify and compare the execution videos of any subject performing the medical clinical skills, thereby obtaining the corresponding assessment results.

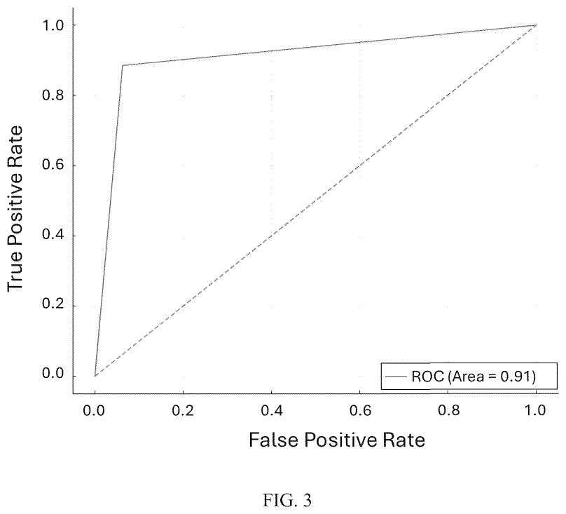

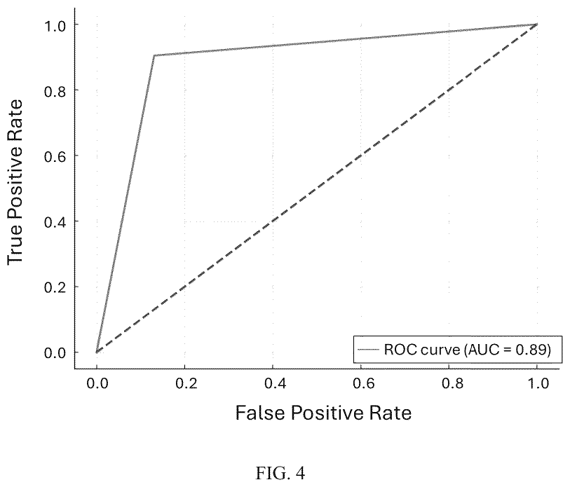

Please also refer to FIG. 3, FIG. 4, and Table 4, wherein FIG. 3 is a schematic diagram of the comprehensive assessment results obtained by using the medical clinical skills assessment system of the present disclosure to process a plurality of training execution videos of CPR and AED operations, and FIG. 4 is a schematic diagram of the comprehensive assessment results obtained by using the medical clinical skills assessment system of the present disclosure to process a plurality of verification execution videos of CPR and AED operations.

In at least one embodiment of the present disclosure, the aforementioned CPR and AED operations are taken as examples of the medical clinical skills. First, the CPR and AED operations and a certain number of execution videos are collected, wherein the number ratio of the training execution videos and the verification execution videos can be 4:1 but is not limited thereto. Then, the medical clinical skills assessment system 1 of the present disclosure is used to perform assessment processing on the training execution videos and the verification execution videos, and the corresponding statistics of prediction accuracy are calculated for each of the target actions of the CPR and AED operations in each video. The prediction accuracy statistics of the training execution videos and the verification execution videos after assessment based on each of the target action items are shown in Table 4. The prediction accuracy statistics of the training execution videos and the verification execution videos are presented as receiver operating characteristic curves (ROC curves) to present the corresponding comprehensive prediction assessment results.

According to Table 4, it can be seen that, in terms of the training execution videos, among the target actions of the CPR and AED operations, except for the prediction accuracy of the power-on timing and operating sequence, which is about 55%, the prediction accuracy of the remaining target actions can reach more than 72%, and even the prediction accuracy of some target actions can reach 100%. In addition, based on the prediction accuracy statistics of the target actions, an ROC curve as shown in FIG. 3 can be formed, with the horizontal axis being the false positive rate (FPR) and the vertical axis being the true positive rate (TPR), and the AUC value (area under the curve (AUC) value) of the ROC curve is about 0.91.

It can also be seen from Table 4 that, in terms of the verification execution videos, among the target actions of the CPR and AED operations, except for the prediction accuracy of the power-on timing and operating sequence, which is about 65%, the prediction accuracy of the remaining target actions can reach more than 72%, and even the prediction accuracy of some target actions can reach 100%. In addition, based on the prediction accuracy statistics of the target actions, an ROC curve as shown in FIG. 4 can be formed, and the AUC value of the ROC curve is about 0.89. It can be seen that applying the medical clinical skills assessment system 1 of the present disclosure to the assessment of the CPR and AED operations can indeed obtain results with a higher prediction accuracy.

TABLE 4

| | | Prediction Accuracy | Prediction Accuracy |
|---|---|---|---|
| Item | | for Training | for Verification |
| No. | Assessment Content of Target Action | Execution Videos | Execution Videos |
| 1 | Confirming environmental safety | 72.22% | 100.0% |
| 2 | Assessing consciousness | 100.0% | 94.44% |
| 3 | Instructing bystanders to call 911 | 100.0% | 100.0% |
| | and obtaining the AED | | |
| 4 | Assessing breathing | 88.89% | 78.95% |
| 5 | Chest compression speed | 83.33% | 100.0% |
| 6 | Chest compression depth | 77.78% | 76.0% |
| 7 | Continuous, uninterrupted chest | 100.0% | 94.44% |
| | compressions | | |
| 8 | Chest compression posture | 94.44% | 91.3% |
| 9 | Timing of power-on and operating | 55.0% | 65.52% |
| | sequence | | |
| 10 | Warning everyone to step away when | 83.33% | 72.22% |
| | shock is advised | | |
| 11 | Immediate CPR after defibrillation | 100.0% | 94.44% |
| 12 | Hand gesture of chest compression | 100.0% | 100.0% |
| 13 | Chest compression position | 100.0% | 90.0% |

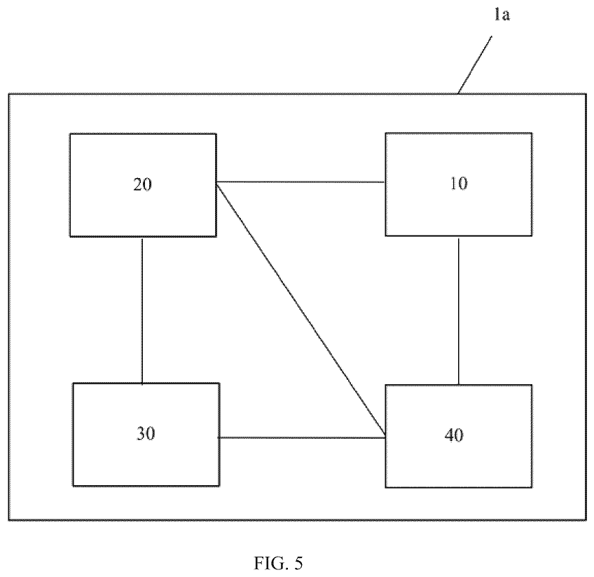

Please refer to FIG. 5, which is a system block diagram of another embodiment of the medical clinical skills assessment system of the present disclosure. As shown in FIG. 5, the medical clinical skills assessment system la of the present disclosure may further comprise a storage module 40, and the storage module 40 is electrically connected to the image processing module 10, the deep learning module 20, and the medical clinical skills assessment module 30, respectively. In at least one embodiment of the present disclosure, the storage module 40 is configured to store at least one of a plurality of execution videos of medical clinical skills loaded into the system, a plurality of annotation information, a plurality of execution segments processed by the image processing module 10, each of the assessment benchmark videos established by the deep learning module 20, the to-be-assessed videos of performing the medical clinical skills received by the medical clinical skills assessment module 30, and the assessment results generated for the to-be-assessed videos. In some embodiments of the present disclosure, the storage module 40 may be a hard disk, a memory, or a combination of other hardware device with data storage function and related data storage software, and the aforementioned data storage software may be stored in the hardware device; however, the present disclosure is not limited thereto. For example, the storage module 40 may also be standalone hardware or software.

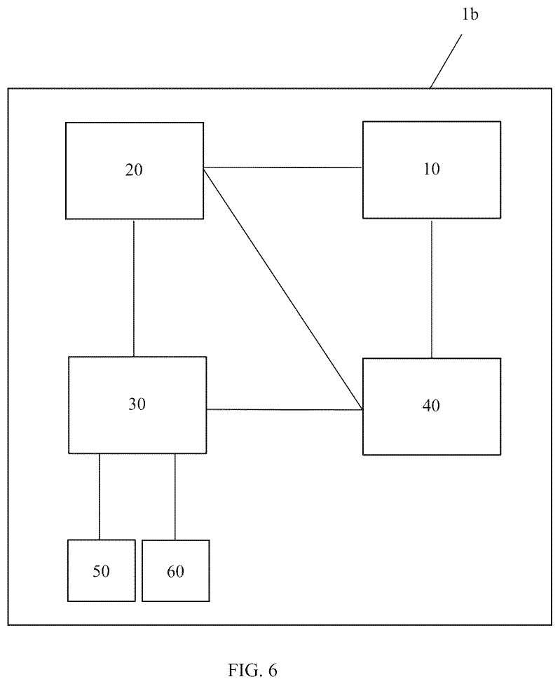

Please also refer to FIG. 6, which is a system block diagram of another embodiment of the medical clinical skills assessment system of the present disclosure. As shown in FIG. 6, the medical clinical skills assessment system 1b of the present disclosure may further comprise an image capture module 50 and an auxiliary recognition module 60. In at least one embodiment of the present disclosure, the image capture module 50 may be a hardware device with an image capture function, such as a camera, which is configured to obtain a to-be-assessed video of the subject performing medical clinical skills. In other words, by combining the image capture module 50, the medical clinical skills assessment system 1b of the present disclosure can perform an assessment process on the currently obtained video to be assessed and generate an assessment result in real time.

In at least one embodiment of the present disclosure, the auxiliary recognition module 60 is configured to generate auxiliary recognition information to assist the medical clinical skills assessment module 30 in performing corresponding action recognition and comparison judgment. In at least one embodiment of the present disclosure, the auxiliary recognition module 60 can be a combination of an infrared sensing camera lens and a 3D computer vision AI auxiliary system, which is used to capture auxiliary judgment images of the subject performing medical clinical skills in real time through 3D human figure and depth sensing and spatial images, so as to compensate for the deficiencies of the to-be-assessed videos obtained by the image capture module 50 (for example, by calculating the bone displacement to assist in judging whether the target action is actually executed). Therefore, for some target actions that are difficult to grasp through videos, such as chest compression depth, the auxiliary recognition module 60 can provide auxiliary recognition information for the medical clinical skills assessment module 30 to perform comparison and judgment.

In at least one embodiment of the present disclosure, the auxiliary recognition module 50 may also be various types of sensors, such as a pressure sensor, a depth sensor, a light sensor, or a voice sensor. In some embodiments of the present disclosure, the pressure sensor is used to assist in sensing whether the force applied to the target action is appropriate; the depth sensor is used to sense whether the displacement of the target action is appropriate; the light sensor is used to sense whether the target action actually passes through or reaches the set position; and the voice sensor is used to sense whether the target action actually executes a specific command or instrument operation. Therefore, for some specific target actions required for different medical clinical skills, the auxiliary recognition module 60 can provide auxiliary recognition information for the medical clinical skills assessment module 30 to perform comparison and judgment.

Accordingly, the medical clinical skills assessment system of the present disclosure can directly perform image processing and content learning by obtaining a plurality of execution videos of medical clinical skills, so as to establish a plurality of assessment benchmark videos of a plurality of target actions for performing medical clinical skills, thereby serving as assessment standards. After the medical clinical skills assessment system of the present disclosure obtains the to-be-assessed videos of the subject performing the medical clinical skills, the to-be-assessed videos can be compared and judged with the plurality of assessment benchmark videos, and the assessment results of the subject's performance of medical clinical skills can be immediately obtained. Compared to the method of learning that must be determined by manual visual judgment, the medical clinical skills assessment system of the present disclosure can more effectively save assessment manpower and costs, and can provide real-time feedback and self-training effects to the subjects, making it more convenient to use.

The above embodiments are merely illustrative in nature and are not intended to limit the embodiments of the subject matter or the applications of such embodiments. In addition, although at least one exemplary embodiment has been presented in the above embodiments, it should be understood that there are still a large number of variations in the present disclosure. It should also be understood that the embodiments described herein are not intended to limit the scope, use, or configuration of the claimed subject matter in any way. On the contrary, the above embodiments will provide a simple guide for those with ordinary knowledge in the art to implement one or more of the embodiments described. Furthermore, various changes may be made to the function and arrangement of elements without departing from the scope defined by the claims, and the claims include known equivalents and all foreseeable equivalents at the time of filing this patent application.

What is claimed is:

1. A medical clinical skills assessment system, comprising:
an image processing module configured to receive a plurality of execution videos of medical clinical skills and a plurality of annotation information, wherein each of the execution videos includes a plurality of target actions executed consecutively, and the image processing module is configured to perform annotation processing for each of the execution videos based on the plurality of annotation information and divide each of the execution videos into a plurality of execution segments, wherein each of the execution segments corresponds to one of the plurality of target actions being executed;
a deep learning module configured to compile and perform recognition processing on the execution segments executing a same target action in the plurality of execution videos, so as to establish a corresponding assessment benchmark video for each of the target actions; and
a medical clinical skills assessment module configured to receive a to-be-assessed video of performing the medical clinical skills and sequentially compare the to-be-assessed video with each of the assessment benchmark videos to determine whether the to-be-assessed video executes each of the target actions, thereby generating a corresponding assessment result.

2. The medical clinical skills assessment system of claim 1, wherein the plurality of annotation information includes a plurality of start markers and a plurality of end markers.

3. The medical clinical skills assessment system of claim 2, wherein the image processing module is configured to mark a start time point of a corresponding target action according to each of the start markers and mark an end time point of the corresponding target action according to each of the end markers.

4. The medical clinical skills assessment system of claim 3, wherein the plurality of annotation information further includes a plurality of assessment markers.

5. The medical clinical skills assessment system of claim 4, wherein the image processing module is configured to mark at least one of an assessment score, a grade, and a performance level of the corresponding target action according to each of the assessment markers.

6. The medical clinical skills assessment system of claim 5, wherein the plurality of assessment markers are provided based on whether each of the target actions in each of the execution videos is fully executed, partially executed, or not executed to give a corresponding assessment result for each of the target actions.

7. The medical clinical skills assessment system of claim 3, wherein the image processing module is configured to perform a batch capture operation based on a time point position of each of the start markers and a corresponding time point position of each of the end markers in the plurality of annotation information to obtain the plurality of execution segments of the execution videos.

8. The medical clinical skills assessment system of claim 1, wherein the plurality of execution videos include a multi-angle image of performing the medical clinical skills.

9. The medical clinical skills assessment system of claim 1, wherein the image processing module is configured to perform facial de-identification processing on each of the execution videos.

10. The medical clinical skills assessment system of claim 1, further comprising an image capture module configured to obtain the to-be-assessed video.

11. The medical clinical skills assessment system of claim 10, further comprising an auxiliary recognition module configured to provide auxiliary recognition information of the to-be-assessed video.

12. The medical clinical skills assessment system of claim 1, wherein the image processing module is connected to a network server to receive at least one of the plurality of execution videos and the plurality of annotation information from the network server.

13. The medical clinical skills assessment system of claim 1, further comprising a storage module configured to store at least one of the plurality of execution videos, the plurality of annotation information, the plurality of execution segments, and each of the assessment benchmark videos.
